(19) United States
(12) Patent Application Publication
(10) Pub. No.: US 2023/0282128 A1
(43) Pub. Date: Sep. 7, 2023

(54) SYSTEM FOR TEACHING ART COURSES BASED ON SMART CLOUD TECHNOLOGY

(71) Applicant: Zhengzhou University of Aeronautics, Zhengzhou (CN)

(72) Inventors: Pengfei LI, Zhengzhou (CN); Qiang LI, Zhengzhou (CN); Qi LIU, Zhengzhou (CN); Yao YAO, Zhengzhou (CN); Wei LI, Zhengzhou (CN); Lijun WANG, Zhengzhou (CN)

(21) Appl. No.: 18/153,279

(22) Filed: Jan. 11, 2023

Related U.S. Application Data
(63) Continuation of application No. PCT/CN2022/079512, filed on Mar. 7, 2022.

(51) Int. Cl. G09B 7/04

(52) U.S. Cl. CPC G09B 7/04

(57) ABSTRACT

Disclosed is a system for teaching art courses based on smart cloud technology, including: a teaching management subsystem, designed for providing online teaching function of art courses as well as student user management function for teachers; a smart learning subsystem, designed with online learning function and course management function for each student user; a resource management subsystem, designed to provide art course resources for the teaching management subsystem and the smart learning subsystem, as well as course management function for art course resources; and a background management subsystem, used to provide system management functions for system administrators.

### CROSS-REFERENCE TO RELATED APPLICATIONS

This application claims priority to PCT/CN2022/079512, filed on Mar. 7, 2022, the contents of which are hereby incorporated by reference.

### TECHNICAL FIELD

The present application relates to the technical field of big data and smart education, and in particular to a system for teaching art courses based on smart cloud technology.

### BACKGROUND

Smart education focuses on improving the quality and efficiency of education and teaching by innovative educational models and means in addition to modern information technology in the field of education (educational management, educational teaching and educational interaction), as well as comprehensively and deeply exploiting new technologies such as Internet, Internet of Things, cloud computing and big data etc., so as to establish a digital, internet-based, intelligent and multimedial modern educational system.

A cloud service supporting platform is required to support large-scale applications in the internet environment and to continuously expand education service application software, so as to support the large number of users and high utilizing frequency of the integrated application solutions for smart education; the cloud service supporting platform is expected to provide an elastic deployment environment for the upper-layer cloud-based applications, and to support services such as global data integration and consolidation, unified identity management and unified authentication of users, virtual community-based interaction and collaboration environment support, large-scale content management and services, interface services and management support for upper-layer applications, and operation and maintenance support such as operation monitoring and resource pool management of the cloud service platform.

Digital teaching resources facilitate students to better understand the content and therefore improve the effectiveness of teaching; yet, it is increasingly challenging for educational users to find matching or suitable courseware despite the more accessible digital teaching resources related to online teaching.

### SUMMARY

In view of solving the above technical problems, the present application provides a system for teaching art courses based on smart cloud technology, and the developed system promotes classroom teacher-student interaction, improves classroom interest, and facilitates analysis and evaluation of students' learning performance, effectively improving students' learning enthusiasm and learning effectiveness.

In order to achieve the above technical objectives, the present application provides a system for teaching art courses based on smart cloud technology, including:
a teaching management subsystem, designed with an online teaching function of art courses as well as a student user management function for teachers, where the online teaching function of art courses includes an electronic course designing function, an assignment function, a classroom sharing function and an intelligent scheduling function, and the student user management function includes a class management function and a student user learning situation analysis function;
a smart learning subsystem, designed with an online learning function and a course management function for each student user, where the online learning function includes a course on-demand function, an assignment function, an error book function and a learning assistant function, and the course management function includes a course schedule function, a course selection function, a learning situation inquiry function and a psychological assessment function;
a resource management subsystem, designed to provide art course resources for the teaching management subsystem and the smart learning subsystem, as well as the course management function, where the course management function includes a course resource download function, a course resource upload function, a course catalog management function, a course resource preview function, a resource statistics function, a resource retrieval function, a comment and evaluation function, and a resource audit function; and
a background management subsystem, designed with a system management function for system administrators, where the system management function includes a points management function, an authority management function, a user management function, a resource management function, a questionnaire management function, a menu management function, an organization management function, and an operation management function.

Optionally, the system for teaching art courses based on smart cloud technology also includes:
a campus management subsystem, used to provide school administrators with a teacher management function, a student user management function and a public affairs management function, where the teacher management function is designed with a salary management function, a teachers' archives management function, an evaluation function of teachers, and a scientific research management function;
the student user management function of the campus management subsystem includes a student user evaluation function, a student user file management function; and
the public affairs management function includes campus payment function, school property management function, and campus distribution function.

Optionally, the system for teaching art courses based on smart cloud technology also includes:
a parent-teacher interaction subsystem, used to provide parents of student users with a student user in-school situation inquiry function, where the student user in-school situation inquiry function includes an assignment checking function, a student user examination information inquiry function, an education information inquiry function, and a tuition payment function.

Optionally, the electronic course designing function is designed to obtain and collate art course resources and then derive art courses through the resource management subsystem;
the art courses include static courses and dynamic courses, where static courses include image painting courses, while the dynamic courses include animation production courses and image dynamic painting teaching courses;
the static course is designed to show static picture works and local details of the static picture works; and
the image dynamic painting teaching courses are obtained by breaking the static course into several frames and collating each frame together; and the breaking of static course includes whole image decomposition and local image decomposition.

Optionally, the intelligent scheduling function is used to generate a course schedule based on course selection of student users, learning situation and teaching situation of teacher users and teacher rating, in which, based on a percentage of student users' learning situation in a total number of student users, a course selection authority is automatically generated through the background management subsystem, and the course selection authority is used to indicate the authority of student users to select courses, and student users with a percentage of 10 percent (%) or less of learning situation are entitled to directly select teacher users.

Optionally, the smart learning subsystem generates learning permissions according to the learning situation, and the learning permissions are used to indicate the learning permissions of the art course, where the learning situation includes learning grade and learning level, the learning level is used to obtain a primary permission of the art course corresponding to the learning level, the learning grade is used to obtain a secondary permission corresponding to the primary permission, and the secondary permission is used to indicate a course level permission of learning the art course.

The learning assistant function is used to provide corresponding learning materials according to the course level permission.

Optionally, the resource management subsystem is used for obtaining course materials through the course resource upload function;
the course resource upload function is accessible to teacher users and system administrators;
the system administrators grant temporary permission to student users to use the course resource upload function through the permission management function, where the temporary permission includes time period to use the upload function, time length to use the upload function, file size and quantity to upload, and users to use the above functions.

Optionally, the background management subsystem sends questionnaires of art courses and teacher users corresponding to the art courses to student users through the questionnaire management function, then adjusts the art courses according to feedback of the questionnaires, and generates ratings against teacher users as well as learning situation of student users, in which the ratings against teacher users are generated according to the learning permissions of student users and a number of student users participating in the questionnaires, and the ratings are input into the campus management subsystem as performance appraisals used to generate performance salaries for teacher users through the salary management function.

The present application discloses the following technical effects:
the present application provides teachers with auxiliary functions for lesson preparation, assignment scheduling and timely mastering of each student's learning effectiveness so as to make targeted coaching measures; moreover, interests of students in learning are enhanced through interaction with teachers in the classroom, and online exercises after the class help students understand their own defects and strengths for self-improvement.

### BRIEF DESCRIPTION OF THE DRAWING

In order to more clearly illustrate the technical schemes in the embodiments of the present application or in the prior art, the following drawings necessary for the embodiments will be briefly described, and it is obvious that the drawings in the following description are only some embodiments of the present application, other drawings may be obtained according to these drawings without any creative labor for a person of ordinary skill in the art.

FIG. 1 shows a structural schematic diagram of a system for teaching art courses based on smart cloud technology provided by the present application.

### DETAILED DESCRIPTION OF THE EMBODIMENTS

For clarity of the objectives, technical schemes and advantages of the embodiments of the present application, the technical schemes in the embodiments of the present application will be described clearly and completely in conjunction with the accompanying drawings in the embodiments of the present application.

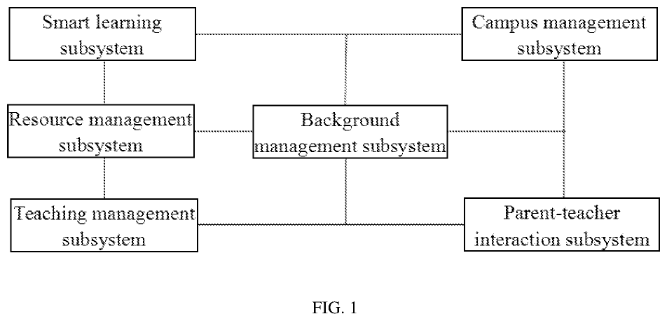

As shown in FIG. 1, the present application provides a system for teaching art courses based on smart cloud technology, including:
a teaching management subsystem, designed with an online teaching function of art courses as well as a student user management function for teachers, where the online teaching function of art courses includes an electronic course designing function, an assignment function, a classroom sharing function and an intelligent scheduling function, and the student user management function includes a class management function and a student user learning situation analysis function;
a smart learning subsystem, designed with an online learning function and a course management function for each student user, where the online learning function includes a course on-demand function, an assignment function, an error book function and a learning assistant function, and the course management function includes a course schedule function, a course selection function, a learning situation inquiry function and a psychological assessment function;
a resource management subsystem, designed to provide art course resources for the teaching management subsystem and the smart learning subsystem, as well as the course management function, where the course management function includes a course resource download function, a course resource upload function, a course catalog management function, a course resource preview function, a resource statistics function, a resource retrieval function, a comment and evaluation function, and a resource audit function; and
a background management subsystem, designed with a system management function for system administrators, where the system management function includes a points management function, an authority management function, a user management function, a resource management function, a questionnaire management function, a menu management function, an organization management function, and an operation management function.

The smart learning subsystem further includes an attendance function, which is used to obtain an attendance information of student users online, and transmit the attendance information to the teaching management subsystem to generate the learning situation, and the attendance function is turned on when a relative position of the smart learning subsystem against the teaching management subsystem is a preset area.

The smart learning subsystem provided by the present application is used for issuing assignment for student users through the assignment function, including individual assignment and collective assignment, where the collective assignment is the assignment required to be completed by several student users together; and the smart learning subsystem generates the learning situation of each student user and the rating of the teacher user according to the average of the collective results of several collective work.

According to the present application, each subsystem in the system for teaching art courses based on smart cloud technology may be realized by ways of different software, for instance, the smart learning subsystem in the system is realized on mobile terminals in the form of application (APP), which is convenient for student users to learn at anytime and anywhere; and the teaching management subsystem is set up in different areas to enable a mobile open function.

The system provided by the present application has strict restrictions on user rights; for example, the teaching management subsystem may only be logged in by teacher users, and the present application adopts face recognition+cloud technology so as to ensure the security of teacher users. The system covers the whole campus network and has not only local area network function but also internet function; it realizes the learning track monitoring of student users through blockchain technology, which provides favorable technical support for student users' self-evaluation; in addition, it provides comprehensive evaluation of student users by big data technology, which provides data reference for employers when student users graduate.

The system of the present application utilizes an online whiteboard+shared classroom technology to optimize the utilization of teacher resources and provide an independent learning platform for students through online teaching. The present application, for the first time, introduces a collective assignment function for the art course, which helps student users experience the working process of collective collaboration by sharing the assignment among each student, providing technical ideas for collaborative design, and, in the collective role, the work of multiple student users may be set up in a certain link for comparison, making it convenient for student users to communicate and learn from each other.

The system provided by the present application provides a comprehensive service platform that integrates “technology, education and public welfare” for smart education. The platform serves teacher users, student users, parents and administrators, providing one-stop solutions for “teaching, learning, management and connection”, and is committed to creating a basic education ecosystem of “resources+platform+services” so as to develop education to be modernized, intelligent and open.

What is claimed is:

1. A system for teaching art courses based on smart cloud technology, comprising:
a teaching management subsystem, designed with an online teaching function of art courses as well as a student user management function for teachers, wherein the online teaching function of art courses comprises an electronic course designing function, an assignment function, a classroom sharing function and an intelligent scheduling function, and the student user management function comprises a class management function and a student user learning situation analysis function;
a smart learning subsystem, designed with an online learning function and a course management function for each student user, wherein the online learning function comprises a course on-demand function, an assignment function, an error book function and a learning assistant function, and the course management function comprises a course schedule function, a course selection function, a learning situation inquiry function and a psychological assessment function;
a resource management subsystem, designed to provide art course resources for the teaching management subsystem and the smart learning subsystem, and the course management function, wherein the course management function comprises a course resource download function, a course resource upload function, a course catalog management function, a course resource preview function, a resource statistics function, a resource retrieval function, a comment and evaluation function, and a resource audit function; and
a background management subsystem, designed with a system management function for system administrators, wherein the system management function comprises a points management function, an authority management function, a user management function, a resource management function, a questionnaire management function, a menu management function, an organization management function, and an operation management function.

2. The system for teaching art courses based on smart cloud technology according to claim 1, wherein the system for teaching art courses based on smart cloud technology also comprises a campus management subsystem, used to provide school administrators with a teacher management function, a student user management function and a public affairs management function, wherein the teacher management function is designed with a salary management function, a teachers' archives management function, an evaluation function of teachers, and a scientific research management function;
the student user management function of the campus management subsystem comprises a student user evaluation function, a student user file management function; and
the public affairs management function comprises a campus payment function, a school property management function, and a campus distribution function.

3. The system for teaching art courses based on smart cloud technology according to claim 2, wherein the system for teaching art courses based on smart cloud technology also comprises:
a parent-teacher interaction subsystem, used to provide parents of student users with a student user in-school situation inquiry function, wherein the student user in-school situation inquiry function comprises an assignment checking function, a student user examination information inquiry function, an education information inquiry function, and a tuition payment function.

4. The system for teaching art courses based on smart cloud technology according to claim 3, wherein the electronic course designing function is designed to obtain and collate art course resources and then derive art courses through the resource management subsystem;
the art courses comprise static courses and dynamic courses, wherein the static courses comprise image painting courses, while the dynamic courses comprise animation production courses and image dynamic painting teaching courses;
the static course is designed to show static picture works and local details of the static picture works; and
the image dynamic painting teaching courses are obtained by breaking the static courses into several frames and collating each frame together; and the breaking of static courses comprises whole image decomposition and local image decomposition.

5. The system for teaching art courses based on smart cloud technology according to claim 4, wherein the intelligent scheduling function is used to generate a course schedule based on a course selection and learning situations of student users in addition to a teaching situation of teacher users and teacher rating, a course selection authority is automatically generated through the background management subsystem based on a percentage of student users' learning situations in a total number of student users, the course selection authority is used to indicate the authority of student users to select courses, and student users with a percentage of 10 percent (%) or less of the learning situations are entitled to directly select teacher users.

6. The system for teaching art courses based on smart cloud technology according to claim 5, wherein the smart learning subsystem generates learning permissions according to the learning situations, and the learning permissions are used to indicate the learning permissions of the art course, each learning situation comprises learning grade and learning level, the learning level is used to obtain a primary permission of the art course corresponding to the learning level, the learning grade is used to obtain a secondary permission corresponding to the primary permission, and the secondary permission is used to indicate a course level permission of learning the art course; and
the learning assistant function is used to provide corresponding learning materials according to the course level permission.

7. The system for teaching art courses based on smart cloud technology according to claim 6, wherein the resource management subsystem is used for obtaining course materials through the course resource upload function;
the course resource upload function is accessible to the teacher users and the system administrators;
the system administrators grant temporary permissions to student users to use the course resource upload function through the permission management function, and each temporary permission comprises a time period to use the upload function, a time length to use the upload function, a file size and a quantity to upload, and users to use the above functions.

8. The system for teaching art courses based on smart cloud technology according to claim 7, wherein the background management subsystem sends questionnaires of art courses and teacher users corresponding to the art courses to student users through the questionnaire management function, then adjusts the art courses according to feedback of the questionnaires, and generates ratings against teacher users as well as learning situations of student users, the ratings against teacher users are generated according to the learning permissions of student users and a number of student users participating in the questionnaires, and the ratings are input into the campus management subsystem as performance appraisals to generate performance salaries for teacher users through the salary management function.
